(19) United States
(12) Patent Application Publication
(10) Pub. No.: US 2026/0188705 A1
(43) Pub. Date: Jul. 2, 2026

(54) CATALYST AND METHOD FOR MANUFACTURING THE SAME

(71) Applicant: HEESUNG CATALYSTS CORPORATION, Siheung-si (KR)

(72) Inventors: Komateedi NARAYANA RAO, Incheon (KR); Sang-Yun HAN, Siheung-si (KR)

(21) Appl. No.: 18/842,912

(22) PCT Filed: Mar. 14, 2024
(86) PCT No.: PCT/KR2024/003258

§ 371 Date: Aug. 30, 2024

(30) Foreign Application Priority Data
Mar. 17, 2023 (KR) 10-2023-0035453

(51) Int. Cl. H01M 4/92; C25B 1/04; C25B 11/054; C25B 11/065; C25B 11/095; H01M 4/88; H01M 4/90

(52) U.S. Cl. CPC H01M 4/926; C25B 1/04; C25B 11/054; C25B 11/065; C25B 11/095; H01M 4/8882; H01M 4/9008; H01M 4/9083

(57) ABSTRACT

The present invention relates to a catalyst and a method of manufacturing the same. Provided is a method of manufacturing a catalyst which includes reacting an aqueous precursor solution including a metal salt, glycerol, and oxalic acid in the presence of a carbon-based carrier.

### TECHNICAL FIELD

The present invention relates to a catalyst and a method of manufacturing the same.

### BACKGROUND ART

As a method of manufacturing a metal nanostructure and a catalyst including the same, the “polyol method” is known.

In the “polyol method,” a polyol is used as a reducing agent, a metal salt precursor is reduced to prepare a metal nanostructure, and the manufactured metal nanostructure is supported on a carbon-based carrier.

A representative example of the “polyol” used in the polyol method is ethylene glycol, which performs a dual function as a solvent and a reducing agent.

The ethylene glycol has the advantages of a low viscosity and excellent reactivity, but has the disadvantages of being difficult to handle due to its strong toxicity and high water-solubility, and limited in its ability to uniformly control the shape and size of the metal nanostructure to evenly distribute the metal nanostructure.

### DISCLOSURE

### Technical Problem

An embodiment has been made in an effort to solve the problem of using ethylene glycol as a “polyol.”

### Technical Solution

In an embodiment, glycerol is used instead of ethylene glycol as a “polyol,” and oxalic acid is used as a “reduction aid” for a polyol reaction.

### Advantageous Effects

In an embodiment, the shape and size of the metal nanostructure are easily controlled under a condition in which glycerol and oxalic acid coexist, and at the same time, the metal nanostructure having the controlled shape and size is supported on a carbon-based carrier to prepare a catalyst.

### DESCRIPTION OF THE DRAWINGS

FIG. 1 illustrates a schematic reaction scheme for a method of manufacturing a metal nanostructure according to an embodiment.

### BEST MODE FOR INVENTION

Advantages and features of the present disclosure and methods for achieving them will become apparent from embodiments described in detail with the accompanying drawings. However, embodiments may not be limited to the embodiments disclosed below.

### DEFINITION OF TERMS

Unless defined otherwise, all terms (including technical terms and scientific terms) used in the present specification have the same meanings as commonly understood by those skilled in the art. Further, unless defined otherwise, all terms defined in generally used dictionaries may not be ideally or exaggeratedly interpreted.

Throughout the present specification, unless explicitly described to the contrary, “comprising” any components will be understood to imply further inclusion of other components rather than the exclusion of any other components. In addition, singular forms are intended to include plural forms, unless the context clearly indicates otherwise.

In the present specification, the “particle size” or “average particle size” may be measured by a method well known to those skilled in the art, and may be measured, for example, by a particle size analyzer, or by transmission electron microscopy or scanning electron microscopy.

### (Method of Manufacturing Catalyst)

In general, a catalyst is manufactured by manufacturing a metal nanostructure using ethylene glycol and supporting the metal nanostructure on a carbon-based carrier.

However, the ethylene glycol is not only difficult to handle due to its strong toxicity and high water-solubility, but also has limited ability to control the shape and size of the metal nanostructure. In particular, the latter is problematic when a catalyst including the metal nanostructure is used as a catalyst for a fuel cell or a catalyst for water electrolysis.

Specifically, when the shape and size of the metal nanostructure are uneven or large, the metal nanostructure may be eluted from the catalyst, which may damage a polymer electrolyte membrane and may deteriorate the performance and durability of a fuel cell or a water electrolysis device.

In an embodiment, glycerol is used instead of ethylene glycol as a “polyol,” and oxalic acid is used as a “reduction aid” for a polyol reaction.

Specifically, an embodiment provides a method of manufacturing a catalyst, the method including reacting an aqueous precursor solution including a metal salt, glycerol, and oxalic acid in the presence of a carbon-based carrier.

More specifically, in an embodiment, the shape and size of the metal nanostructure are easily controlled under a condition in which glycerol and oxalic acid coexist, and the metal nanostructure having the controlled shape and size is supported on a carbon-based carrier to prepare a catalyst. The process of manufacturing a metal nanostructure and the process of supporting the metal nanostructure on a carbon-based carrier are performed in-situ.

As a result of supporting the metal nanostructure having the controlled shape and size on the carbon-based carrier, an embodiment may provide a catalyst having excellent performance and durability. In particular, the catalyst is suitable for use as a catalyst for a fuel cell or a catalyst for water electrolysis.

Hereinafter, raw materials for the catalyst according to an embodiment and a method of manufacturing a catalyst using these raw materials will be described in detail.

### Metal Salt

The metal salt is a precursor of a metal nanostructure.

A metal constituting the metal salt may be a noble metal, a transition metal, an alloy thereof, or a mixture thereof. Specifically, the noble metal may include platinum (Pt), ruthenium (Ru), osmium (Os), iridium (Ir), palladium (Pd), an alloy thereof, or a mixture thereof, and may be, for example, platinum. In addition, the transition metal may include cobalt (Co), iron (Fe), nickel (Ni), zinc (Zn), tin (Sn), manganese (Mn), copper (Cu), scandium (Sc), titanium (Ti), vanadium. (V), chromium (Cr), zirconium (Zr), yttrium (Y), niobium (Nb), an alloy thereof, or a mixture thereof.

Meanwhile, the metal salt is in the form of salts and may include nitrate, sulfate, acetate, chloride, oxide, or a combination thereof of the metal.

Specifically, the metal salt is a metal salt including platinum (Pt), and may be dinitro-diamine platinum nitrate, chloroplatinic acid, potassium chloroplatinate, platinum oxalate, monoethanolamine platinum hydroxide, triethanolamine platinum hydroxide, or a combination thereof.

For example, the metal salt may be dinitro-diamine platinum nitrate. As a more specific example, the dinitro-diamine platinum nitrate may be a basic platinum precursor such as (TEA)-₂Pt(OH)₆, (MEA)-₂Pt(OH)₆, [Pt(NH₃)₄]Cl₂, [Pt(NH₃)₄](NO₃)₂, [Pt(NH₃)₄](OH)₂, Pt(NH₃)₂Cl₂, or (NH₄)₂[PtCl₄].

### Glycerol

The glycerol is a type of polyol compound and is represented by the following Chemical Formula 1:

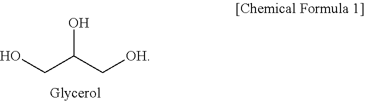

The glycerol, which is a by-product of biodiesel, may be easily and inexpensively purchased in the industry, and is less toxic than ethylene glycol and is thus used as a food additive.

In theory, since the glycerol is a type of polyol compound, the glycerol may function as a solvent and a reducing agent to reduce the metal salt.

However, the polyol used in the “polyol method” needs to have a low viscosity. Since the glycerol has a relatively higher viscosity than the ethylene glycol, the glycerol has not been handled in the “polyol method” so far.

In an embodiment, in order to lower the viscosity of the glycerol, the glycerol is dissolved in water and used in the form of an aqueous solution. Specifically, an aqueous precursor solution including a metal salt, glycerol, and oxalic acid is reacted. More details about this will be described below.

Meanwhile, the glycerol serves as a template and may make the shape and size uniform during a process of converting the metal salt into a metal nanostructure. As a result, the metal nanostructure may be evenly distributed by using the glycerol.

### Oxalic Acid

The oxalic acid may assist the reduction function of the glycerol in the process of converting the metal salt into the metal nanostructure while maintaining the pH of the reaction between the metal salt and the glycerol. In this sense, the oxalic acid serves as a “reduction aid.”

Specifically, the aqueous precursor solution including the metal salt, glycerol, and oxalic acid may further include formic acid. Here, the formic acid may be converted from a part of the oxalic acid.

A molar ratio of the metal salt to the oxalic acid may be 1:0.5 to 1:12, specifically, 1:3 to 1:10, more specifically, 1:4 to 1:9, and for example, 1:5 to 1:7. Within the range, the role of oxalic acid as a pH adjustment and reduction aid may be improved.

### Carbon-Based Carrier

The carrier may be a carbon-based carrier.

The carbon-based carrier may include carbon black, graphite, carbon nanofibers, graphitized carbon nanofibers, carbon nanotubes, carbon nanohorns, carbon nanowires, or a combination thereof. The carbon black may include, for example, denka black, ketjen black, acetylene black, channel black, furnace black, lamp black, thermal black, or a combination thereof.

A specific surface area of the carbon-based carrier may be 250 m²/g to 1,200 m²/g. When the specific surface area of the carbon-based carrier is 250 m²/g or more, an area to which the metal nanostructure is attached may be increased, and an effective surface area may be increased by dispersing the metal nanostructure at a high level. Meanwhile, in a case where the specific surface area of the carbon-based carrier is more than 1,200 m²/g, when an electrode for a fuel cell is formed, a presence rate of ultrafine pores (less than about 20 angstroms), which are difficult for an ion exchange resin to penetrate, increases, which may lower the utilization efficiency of the catalyst.

The aqueous precursor solution including a metal salt, glycerol, and oxalic acid may include the metal salt and the carbon-based carrier in a weight ratio of 30:70 to 95:5, 40:60 to 95:5, or 50:50 to 95:5. The weight ratio may be the same as the weight ratio of the metal nanostructure to the carbon-based carrier in the finally obtained catalyst. In the finally obtained catalyst, the weight ratio of the metal nanostructure to the carbon-based carrier may be appropriately controlled in consideration of the performance as a catalyst.

### Process of Manufacturing Metal Nanostructure and Catalyst Including the Same

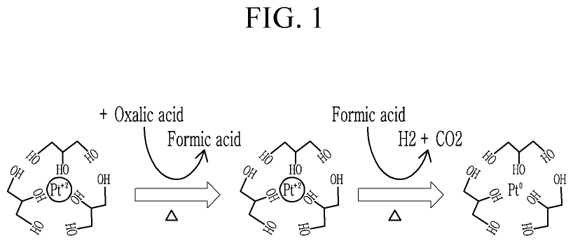

FIG. 1 illustrates a schematic reaction scheme of a reaction of the aqueous precursor solution including a metal salt, glycerol, oxalic acid, and water.

Specifically, when a part or all of the oxalic acid reacts with a part of the glycerol and is converted into formic acid, the part of the glycerol may react with the part or all of the oxalic acid to produce 2-(2,3-dihydroxypropoxy)-2-oxoacetic acid or glycerol mono oxalate; 2,3-dihydroxypropyl formate or glycerol mono formate may be produced through a carbon dioxide removal reaction of the 2-(2,3-dihydroxypropoxy)-2-oxoacetic acid; and formic acid may be produced through a hydrolysis reaction of the 2,3-dihydroxypropyl formate. In this case, glycerol may be reproduced together with the formic acid.

Meanwhile, although not illustrated in FIG. 1, the reaction of the aqueous precursor solution including a metal salt, glycerol, oxalic acid, and water is performed in the presence of the carbon-based carrier.

Accordingly, the reaction between the oxalic acid and glycerol, the reaction between the metal salt and glycerol, the reaction of supporting the metal nanostructure converted from the metal salt on the carbon-based carrier, and the like may all be performed in-situ.

The reacting of the aqueous precursor solution including the metal salt, glycerol, and oxalic acid in the presence of the carbon-based carrier may be performed under conditions of a heat treatment.

The heat treatment may be performed in a temperature range of 60° C. or higher to 110° C. or lower, and specifically, 80° C. or higher to 100° C. or lower, for 1 hour or longer to 24 hours or shorter, specifically, 3 hours or longer to 10 hours or shorter, and for example, 5 hours or longer to 8 hours or shorter.

The heat treatment may be performed in a non-oxidizing atmosphere, for example, in a reducing atmosphere (hydrogen gas atmosphere or the like).

In the reacting of the aqueous precursor solution including the metal salt, glycerol, and oxalic acid in the presence of the carbon-based carrier, due to formic acid converted from the part of the oxalic acid and the remainder of the oxalic acid, the pH may be maintained in a range of pH 1 or higher to pH 9 or lower, specifically, pH 2 or higher to pH 5 or lower, and for example, pH 2 or higher to pH 3 or lower. Here, in order to more precisely control the pH to a desired range, a pH adjuster such as nitrate, sulfate, acetate, NaOH, or NH₄OH may be further used.

In the reacting of the aqueous precursor solution including the metal salt, glycerol, and oxalic acid in the presence of the carbon-based carrier, a viscosity needs to be controlled.

The viscosity of the aqueous precursor solution may be in a range of 10 cP or more to 1,000 cP or less, specifically, 100 cP or more to 500 cP or less, and for example, 150 cP or more to 300 cP or less.

For the viscosity control, a content of the water may be set to 50 wt % or more to 99 wt % or less, specifically, 70 wt % or more to 90 wt % or less, and for example, 70 wt % or more to 80 wt % or less, based on 100 wt % of the aqueous precursor solution.

Here, the need for viscosity control is as described above.

### (Specific Method of Manufacturing Catalyst)

Hereinafter, the method of manufacturing a catalyst according to an embodiment will be described in more detail.

The reacting of the aqueous precursor solution including the metal salt, glycerol, and oxalic acid in the presence of the carbon-based carrier may include a first step of preparing a slurry by dispersing a carbon-based carrier in an aqueous glycerol solution; a second step of reacting the slurry prepared in the first step with an aqueous metal salt solution; and a third step of reacting a reaction product of the second step with an aqueous oxalic acid solution.

### First Step

As described above, in an embodiment, in order to lower the viscosity of the glycerol, the glycerol is dissolved in water and used in the form of an aqueous solution.

In this regard, the aqueous glycerol solution of the first step may include glycerol and water in a weight ratio of 10:90 to 50:50, and specifically, 20:80 to 40:60.

In an embodiment, in order to control the shape and size of the metal nanostructure while uniformly dispersing the carbon-based carrier in the aqueous glycerol solution, before the slurry prepared in the first step is added to the second step, a particle size of solids in the slurry may be controlled.

In this regard, before the slurry prepared in the first step is added to the second step, a step of wet-grinding or nano-milling the slurry to prepare a slurry having D90 of solids of less than 10 μm, and specifically, less than 4 μm, may be further included.

### Second Step

The aqueous metal salt solution of the second step may include a metal salt and water in a weight ratio of 30:70 to 70:30, and specifically, 40:60 to 60:40.

When the slurry prepared in the first step is reacted with the aqueous metal salt solution, the weight ratio of the metal salt to the carbon-based carrier may be set to 50:50 to 80:20.

The reaction between the slurry prepared in the first step and the aqueous metal salt solution may be performed under conditions of a heat treatment.

The heat treatment may be performed in a temperature range of 60° C. or higher to 110° C. or lower, and specifically, 80° C. or higher to 100° C. or lower, for 0.1 hours or longer to 24 hours or shorter, specifically, 3 hours or longer to 10 hours or shorter, and for example, 5 hours or longer to 8 hours or shorter.

The heat treatment may be performed in a non-oxidizing atmosphere, for example, in a reducing atmosphere (hydrogen gas atmosphere or the like).

### Third Step

The aqueous oxalic acid solution of the third step may include oxalic acid and water in a weight ratio of 1:1 to 1:10, and specifically, 1:3 to 1:8.

When the reaction product of the second step is reacted with the aqueous oxalic acid solution, a molar ratio of the metal salt to the oxalic acid may be 1:0.5 to 1:12, specifically, 1:3 to 1:10, more specifically, 1:4 to 1:9, and for example, 1:5 to 1:7. Within the range, the role of oxalic acid as a pH adjustment and reduction aid may be improved.

In the third step, the aqueous oxalic acid solution may be supplied at a rate of 30 to 70 ml/min, and specifically, 40 to 60 ml/min while being controlled to a temperature range of 50 to 90° C., and specifically, 60 to 80° C., and then mixed with the reaction product of the second step.

After the supply is completed, the temperature of the mixture of the reaction product of the second step and the aqueous oxalic acid solution is within a range of 90 to 120° C., and specifically, 100 to 110° C., and mixing is performed for 5 to 10 hours while maintaining the temperature range, such that nucleation and dispersion of the metal nanostructure may be uniform.

### Fourth Step

After the third step, a fourth step of sequentially performing aging, filtration, washing, and drying may be further included. This may be regarded as a post-treatment process to increase the purity of the finally obtained metal nanostructure.

### (Catalyst)

In an embodiment, a catalyst including a carbon-based carrier; and a metal nanostructure supported on the carbon-based carrier is provided, wherein the catalyst inevitably further includes more than 0 ppm to less than 40 ppm of glycerol.

The catalyst of an embodiment may be a catalyst manufactured by the method described above and including an activated metal nanostructure. The activated metal nanostructure strongly adsorbs materials used in the manufacturing process. Accordingly, when the catalyst of an embodiment is analyzed, the materials used in the manufacturing process may be detected.

### Remaining Amount of Glycerol

According to the method described above, since glycerol is used as a solvent and a reducing agent, the glycerol inevitably remains on a surface of the finally obtained catalyst.

In the catalyst of an embodiment, a remaining amount of the glycerol may be measured by LC-MS method. Specifically, 10 g of a sample is treated with 100 g of water (H₂O) and 5 g of ethanol and then heated at about 90° C. for 4 hours. In this process, the glycerol remaining on the surface of the catalyst is released by the water and ethanol.

The released glycerol is measured by LC-MS and HPLC. Here, a dimethyl-polysiloxane column, which is a non-polar column, is used, a toluene standard solution at a concentration of 4 g/L is used, and the amount of toluene added is standardized to 4 μg to measure a peak of an organic compound. In the chromatogram obtained above, areas between n-hexane and n-hexadecane are added and converted into mass units of toluene, and the amount of glycerol is calculated. Based on the amount (g) of the sample used in the experiment, the amount (μg) of glycerol is expressed in a unit of ppm, ppb, or wt %.

As a result of the LC-MS measurement as described above, in the catalyst of an embodiment, a remaining amount of the glycerol may be more than 0 ppm to less than 50 ppm, specifically, more than 0 ppm to less than 40 ppm, and more specifically, 0 ppm or more to 30 ppm or less.

### Remaining Amount of Reactants

According to the method described above, in addition to the glycerol, a metal salt, oxalic acid, formic acid, and the like are used as reactants. Accordingly, according to the method described above, the reactants may inevitably or selectively remain on the surface of the finally obtained catalyst.

A remaining amount of the reactants may also be measured by LC-MS method. The specific LC-MS measurement method is the same as above, except that “glycerol” is changed to each of the reactants.

Specifically, in the catalyst of an embodiment, a remaining amount of the oxalic acid may be 0 ppb or more to less than 20 ppb, specifically, 0 ppb or more to 15 ppb or less, and more specifically, 0 ppb or more to 10 ppb or less.

In addition, in the catalyst of an embodiment, a remaining amount of the formic acid may be 0 wt % or more to less than 5 wt %, specifically, 0.1 wt % or more to 3 wt % or less, and more specifically, 0.1 wt % or more to 2 wt % or less.

### Remaining Amount of pH Adjuster

According to the method described above, since a pH adjuster such as nitrate, sulfate, acetate, NaOH, NH₄OH, or the like may be further used, the pH adjuster may also optionally remain. A remaining amount of the pH adjuster may also be measured by LC-MS method. The specific LC-MS measurement method is the same as above, except that “glycerol” is changed to the pH adjuster.

### Remaining Amount of Nitrogen Compound

In a case where the ethylene glycol is used according to the commonly known “polyol” method, when a basic platinum precursor such as (TEA)-₂Pt(OH)₆, (MEA)-₂Pt(OH)₆, [Pt(NH₃)₄]Cl₂, [Pt(NH₃)₄](NO₃)₂, [Pt(NH₃)₄](OH)₂, Pt(NH₃)₂Cl₂, or (NH₄)₂[PtCl₄] is used, an excessive amount of nitrogen compound may inevitably remain on the surface of the finally obtained catalyst.

However, in a case where the glycerol is used instead of the ethylene glycol according to the method described above, even when the basic platinum precursor is used, the maximum amount of nitrogen compound remaining in the finally obtained catalyst may be reduced.

As a result, in the catalyst of an embodiment, the maximum remaining amount of the nitrogen compound may be 0 ppm or more to 50 ppm or less.

The maximum remaining amount of the nitrogen compound may be measured by N₂-TPD method. For example, the maximum remaining amount of the nitrogen compound may be determined by a method of loading 0.1 g of sample into a vertical gas flow reactor using quartz wool, transferring 2 L of N₂ gas to the reactor at a ramp rate of 10° C./min until the temperature is increased to 400° C., and then measuring exhaust gas using MKS FT-IR analyzer.

### Shape and Size of Metal Nanostructure

When the ethylene glycol and the polyvinylpyrrolidone are used according to the generally known “polyol” method, it is difficult to uniformly control the shape and size of the metal nanostructure in the finally obtained catalyst to achieve uniform dispersion.

However, when the glycerol and the oxalic acid are used according to the method described above, the shape and size of the metal nanostructure in the finally obtained catalyst may be uniformly controlled to achieve uniform dispersion. As a result, the metal nanostructure of an embodiment may be a spherical metal nanoparticle.

When the metal nanostructure of an embodiment is subjected to XRD analysis, a crystallite diameter of a (111) plane may be 0.1 nm or more to 20 nm or less, specifically, 0.5 nm or more to 15 nm or less, and for example, 1 nm or more to 10 nm or less.

Here, the “crystallite diameter” refers to a size of crystals connected on the (111) plane of the metal nanostructure, and does not include a particle size of the carbon-based carrier to be described below. The crystallite diameter may be calculated by the Scherrer equation from an XRD peak half width for the metal nanostructure of an embodiment or the catalyst including the same.

In addition, when the metal nanostructure of an embodiment is subjected to TEM analysis, a particle size to be observed may be 0.1 nm or more to 20 nm or less, specifically, 0.5 nm or more to 15 nm or less, and for example, 1 nm or more to 10 nm or less.

### Weight Retention During Heat Treatment of Catalyst

When the glycerol and the oxalic acid are used, a weight loss of the finally obtained catalyst may be suppressed.

The catalyst of an embodiment may have a weight retention of 97 wt % to 100 wt % when subjected to a heat treatment at 250° C., the weight retention being measured according to Equation 1:

$$Weight retention of catalyst = 100 * ( A - B ) / A \qquad [ Equation 1 ]$$

In Equation 1,
A is a weight of the catalyst before the heat treatment, and
B is a weight of the catalyst after the heat treatment.

### (Electrode for Fuel Cell, Membrane-Electrode Assembly, and Fuel Cell)

An embodiment provides an electrode for a fuel cell including the catalyst described above and an ionomer mixed with the catalyst.

An embodiment provides a membrane-electrode assembly including an anode, a cathode, and an ion exchange membrane between the anode and the cathode, wherein the anode, the cathode, or both correspond to the electrode for a fuel cell described above.

An embodiment provides a fuel cell including the membrane-electrode assembly.

Since the electrode, the membrane-electrode assembly, and the fuel cell are the same as those for the general electrode for a fuel cell, membrane-electrode assembly, and fuel cell, except that they include the catalyst described above, detailed descriptions are omitted.

### MODE FOR INVENTION

Hereinafter, specific examples of the present invention will be described. However, the examples described below are only intended to specifically illustrate or explain the present invention, and are not intended to limit the scope of the present invention.

### Example 1

(1) Using a high shear dispersion mixer, a carbon-based carrier was dispersed in an aqueous glycerol solution in which glycerol and water (H₂O) were mixed in a weight ratio of 50:50. The aqueous glycerol solution in which the carbon-based carrier was dispersed was wet-ground to obtain a slurry having D90 of solids of less than 10 μm.
(2) An aqueous metal salt solution in which a metal salt and water (H₂O) were mixed in a weight ratio of 50:50 was prepared. The aqueous metal salt solution was added to the glycerol slurry in which the carbon-based carrier was dispersed and then heated to 100° C. for 1 hour. When the aqueous metal salt solution was added, a weight ratio of the metal salt to the carbon-based carrier was set to 60:40.
(3) An aqueous oxalic acid solution in which oxalic acid and water (H₂O) were mixed in a weight ratio of 1:5 was prepared. The aqueous oxalic acid solution was heated to 70° C., and then the heated aqueous oxalic acid solution was pumped into the mixture in which step (2) was completed. Here, the molar ratio of the metal salt to the oxalic acid was set to 1:6, taking into account the size distribution of the final catalyst.
(4) The final reaction mixture was treated at 100° C. for 5 hours, cooled to room temperature, and aged for 12 hours with stirring at 500 rpm. The aged catalyst slurry was filtered and washed with hot water to remove water, and oxalic acid and a derivative thereof. The washed catalyst cake reached a final pH of 6.5. The catalyst cake that reached the above pH was vacuum-dried at 100° C. and then further dried at 200° C. for 12 hours in a N₂ purged oven dryer.

### Example 2

A catalyst was manufactured in the same manner as in Example 1, except that the weight ratio of glycerol to water (H₂O) in step (1) was changed to 40:60.

### Example 3

A catalyst was manufactured in the same manner as in Example 1, except that the weight ratio of glycerol to water (H₂O) in step (1) was changed to 30:70.

### Example 4

A catalyst was manufactured in the same manner as in Example 1, except that the weight ratio of glycerol to water (H₂O) in step (1) was changed to 20:80.

### Example 5

A catalyst was manufactured in the same manner as in Example 1, except that the weight ratio of glycerol to water (H₂O) in step (1) was changed to 10:90.

### Example 6

(1) One or more carbon-based carriers were dispersed in an aqueous glycerol solution in which glycerol and water (H₂O) were mixed in a weight ratio of 30:70, and then nano-milling was performed to obtain a slurry having D90 of solids of less than 4 μm.
(2) An aqueous metal salt solution in which a metal salt and water (H₂O) were mixed in a weight ratio of 50:50 was prepared. The aqueous metal salt solution was added to the glycerol slurry in which the carbon-based carrier was dispersed and then heated to 100° C. for 1 hour. When the aqueous metal salt solution was added, a weight ratio of metal salt:carbon-based carrier in the aqueous metal salt solution was set to 60:40.
(3) An aqueous oxalic acid solution in which oxalic acid and water (H₂O) were mixed in a weight ratio of 1:3 was prepared. The aqueous oxalic acid solution was heated to 80° C., and then the heated aqueous oxalic acid solution was pumped into the mixture in which step (2) was completed. Here, the molar ratio of the metal salt to the oxalic acid was set to 1:2, taking into account the size distribution of the final metal nanostructure.
(4) The final reaction mixture was treated at 100° C. for 8 hours, cooled to room temperature, adjusted to pH 2, and aged for 12 hours with stirring at 500 rpm. The aged catalyst slurry was filtered and washed with hot water to remove water, and oxalic acid and a derivative thereof. The washed catalyst cake reached a final pH of 6. The catalyst cake that reached the above pH was vacuum-dried at 100° C. and then further dried at 200° C. for 12 hours in a N₂ purged oven dryer.

### Comparative Example 1

(1) A carbon-based carrier was dispersed in ethylene glycol using a high shear dispersion mixer. The aqueous ethylene glycol solution in which the carbon-based carrier was dispersed was wet-ground to obtain a slurry having D90 of solids of less than 10 μm.
(2) An aqueous metal salt solution in which a metal salt and water (H₂O) were mixed in a weight ratio of 50:50 was prepared. The aqueous metal salt solution was added to the ethylene glycol slurry in which the carbon-based carrier was dispersed and then heated to 100° C. for 1 hour. When the aqueous metal salt solution was added, a weight ratio of the metal salt in the aqueous metal salt solution to the carbon-based carrier in the slurry prepared in step (1) was set to 60:40.
(3) The final reaction mixture was adjusted to pH 9.5, heated at 180° C. for 5 hours, cooled to room temperature, and aged for 12 hours with stirring at 500 rpm. The aged catalyst slurry was filtered and washed with hot water to remove water, and oxalic acid and a derivative thereof. The washed catalyst cake reached a final pH of 5. The catalyst cake that reached the above pH was vacuum-dried at 100° C. and then further dried at 200° C. for 12 hours in a N₂ purged oven dryer.

### Evaluation Example 1: Evaluation of Catalyst Performance

### Evaluation Example 1-1: Remaining Amount of Each Material Remaining on Catalyst Surface

For the catalysts of Examples and Comparative Example, the remaining amount of each material remaining on the catalyst surface was evaluated according to the following methods and the evaluation results are shown in Table 1.

### (1) Glycerol, Oxalic Acid, and Formic Acid

For the catalysts of Examples and Comparative Example, the remaining amount of each of glycerol, oxalic acid, and formic acid was evaluated. The remaining amount of each material may be measured by LC-MS method.

Specifically, 10 g of a sample was treated with 100 g of water (H₂O) and 5 g of ethanol and then heated at about 90° C. for 4 hours. In this process, the glycerol remaining on the surface of the metal nanostructure was released by the water and ethanol.

The released glycerol was measured by LC-MS and HPLC. Here, a dimethyl-polysiloxane column, which is a non-polar column, was used, a toluene standard solution at a concentration of 4 g/L was used, and the amount of toluene added was standardized to 4 μg to measure a peak of an organic compound. In the chromatogram obtained above, areas between n-hexane and n-hexadecane were added and converted into mass units of toluene, and the amount of glycerol was calculated. Based on the amount (g) of the sample used in the experiment, the amount (μg) of glycerol was expressed in a unit of ppm.

In addition, oxalic acid and formic acid were measured in the same manner as glycerol and expressed in units of ppb and wt %, respectively.

### (2) Nitrogen Compound

Meanwhile, the maximum remaining amount of the nitrogen compound was evaluated for the catalysts of Examples and Comparative Example.

The maximum remaining amount of the nitrogen compound may be measured by N₂-TPD method. For example, the maximum remaining amount of the nitrogen compound may be determined by a method of loading 0.1 g of sample into a vertical gas flow reactor using quartz wool, transferring 2 L of N₂ gas to the reactor at a ramp rate of 10° C./min until the temperature is increased to 400° C., and then measuring exhaust gas using MKS FT-IR analyzer.

TABLE 1

| | | | | Nitrogen |
|---|---|---|---|---|
| | Glycerol | Oxalic acid | Formic acid | compound |
| | (ppm) | (ppb) | (wt %) | (Max ppm) |
| Example 1 | 6 | 1.3 | 0.7 | 22.3 |
| Example 2 | 9 | 2.3 | 0.8 | 25.4 |
| Example 3 | 8 | 1.1 | 0.8 | 32.4 |
| Example 4 | 15 | 1 | 0.3 | 15.2 |
| Example 5 | 9.3 | 0.9 | 0.4 | 14.6 |
| Example 6 | 4.3 | 1.3 | 0.1 | 8.4 |
| Comparative | 0 | 0 | 0 | 76 |
| Example 1 | | | | |

### Evaluation Example 1-2: Crystallite Diameter, Particle Size, and Weight Retention of Catalyst

For the catalysts of Examples and Comparative Example, the crystallite diameter, the particle size, and the weight retention were evaluated according to the following methods and the evaluation results are shown in Table 2.

### (1) Crystallite Diameter

For the catalysts of Examples and Comparative Example, the crystallite diameter of the (111) plane was evaluated by XRD analysis.

### (2) Particle Size

For the catalysts of Examples and Comparative Example, the particle size was evaluated by TEM analysis.

### (3) Weight Retention During Heat Treatment

Each of the catalysts of Examples and Comparative Example was subjected to a heat treatment at 250° C., and a weight retention according to Equation 1 was evaluated:

$$Weight retention = 100 * ( A - B ) / A \qquad [ Equation 2 ]$$

In Equation 1,
A is a weight of the catalyst before the heat treatment, and
B is a weight of the catalyst after the heat treatment.

TABLE 2

| | Crystallite | | Weight retention |
|---|---|---|---|
| | diameter | Particle | during heat |
| | of (111) plane | size | treatment |
| | (nm) | (nm) | (wt %) |
| Example 1 | 2.95 | 2.7 | 97.3 |
| Example 2 | 2.65 | 2.2 | 99.2 |
| Example 3 | 2.28 | 1.76 | 99.6 |
| Example 4 | 2.30 | 2.4 | 100.0 |
| Example 5 | 2.98 | 2.97 | 99.7 |
| Example 6 | 1.88 | 1.58 | 98.5 |
| Comparative | 3.42 | 2.8 | 98.3 |
| Example 1 | | | |

### Evaluation Example 1-3: Modifications of Manufacturing Process and Evaluation

A catalyst was manufactured in the same manner as in Example 1, except that the molar ratio of the metal salt to the oxalic acid in the aqueous precursor solution was changed according to Table 3.

The crystallite diameter of the (111) plane of the catalyst was evaluated in the same manner as in Evaluation Example 2, and the results are shown in Table 3.

TABLE 3

| | | Catalyst: |
|---|---|---|
| | Manufacturing process: | crystallite diameter |
| | molar ratio of metal | of (111) plane |
| | salt to oxalic acid | (nm) |
| Reference Example 1 | 1:12 | 3.1 |
| Reference Example 2 | 1:10 | 2.9 |
| Reference Example 3 | 1:8 | 2.8 |
| Reference Example 4 | 1:6 | 2.5 |
| Reference Example 5 | 1:4 | 2.6 |
| Reference Example 6 | 1:2 | 1.9 |
| Reference Example 7 | 1:1 | 1.5 |
| Reference Example 8 | 1:0.8 | 1.6 |
| Reference Example 9 | 1:0.5 | 1.5 |
| Reference Example 10 | 1:0 | 1.4 |

### Evaluation Example 2: Evaluation of Catalyst Performance when Applied to Fuel Cell

For the catalysts of Examples, the catalyst performance when applied to a fuel cell was measured, and the results are shown in Table 4.

### (1) Method of Manufacturing Fuel Cell

A catalyst loading amount for an anode was 0.10 mg/cm² based on Pt, and the anode was produced by the decal method. Nafion ionomer (5 wt % Nafion Dispersion, DuPont Co., USA) was used, and an ionomer/carbon ratio was 0.9.

A catalyst loading amount for a cathode was 0.35 mg/cm² based on Pt, and the cathode was produced by the decal method. Nafion ionomer (5 wt % Nafion Dispersion, DuPont Co., USA) was used, and an ionomer/carbon ratio was 0.9.

The catalyst in each of the anode and the cathode is each of the catalysts of Examples and Comparative Example.

As an electrolyte membrane for producing a membrane-electrode assembly (MEA), NRE211 product (DuPont Co.) was used.

The anode and the cathode were placed on both sides of the electrolyte membrane and then pressed at a pressure of 30 bar and 150° C. for 10 minutes to produce a membrane-electrode assembly (MEA).

### (2) Method of Evaluating Fuel Cell

A 5 cm*5 cm single cell was connected to a voltmeter and an ammeter. The voltmeter and the ammeter were used to measure a voltage and a current at different points on an IV curve. The voltage and current measured values were recorded at each point of the IV curve and plotted on a graph to crease an IV curve with the voltage on the y-axis and the current on the x-axis. Here, RH100% indicates 100% relative humidity.

Meanwhile, in order to measure an open-circuit voltage (OCV), first, the voltmeter was connected to the fuel cell without connecting a load. The voltmeter reads the highest voltage that may be produced by the cell.

TABLE 4

| | Battery manufacturing | | | | |
|---|---|---|---|---|---|
| | method | | Evaluation result at RH100% | | |
| | | Cathode | | Max | Current |
| | I/C | (mg/cm²) | OCV(V) | power(W) | mA@0.6 V |
| Example 2 | 1.0 | 0.375 | 0.963 | 17.46 | 1080 |
| | 1.1 | 0.342 | 0.956 | 18.36 | 1140 |
| Example 3 | 1.0 | 0.353 | 0.957 | 17.42 | 1080 |
| | 1.1 | 0.342 | 0.966 | 18.25 | 1170 |
| Example 4 | 1.0 | 0.349 | 0.963 | 18.69 | 1169 |
| | 1.1 | 0.351 | 0.959 | 18.36 | 1170 |

### Results

According to Tables 1 to 4, in an embodiment represented by Examples, the shape and size of the metal nanostructure are easily controlled under a condition in which glycerol and oxalic acid coexist, and the metal nanostructure having the controlled shape and size is supported on a carbon-based carrier to prepare a catalyst. The process of manufacturing a metal nanostructure and the process of supporting the metal nanostructure on a carbon-based carrier are performed in-situ.

As a result of supporting the metal nanostructure having the controlled shape and size on the carbon-based carrier, an embodiment may provide a catalyst having excellent performance and durability. In particular, the catalyst is suitable for use as a catalyst for a fuel cell or a catalyst for water electrolysis.

While the present invention has been described in connection with what is presently considered to be practical embodiments, it is to be understood that the present invention is not limited to the disclosed embodiments, but, on the contrary, is intended to cover various modifications and equivalent arrangements included within the spirit and scope of the appended claims.

1. A method of manufacturing a catalyst, comprising reacting an aqueous precursor solution including a metal salt, glycerol, and oxalic acid in the presence of a carbon-based carrier.

2. The method of claim 1, wherein
the aqueous precursor solution including the metal salt, glycerol, and oxalic acid includes the metal salt and the carbon-based carrier in a weight ratio of 30:70 to 95:5.

3. The method of claim 1, wherein
a molar ratio of the metal salt to the oxalic acid is 1:0.5 to 1:12.

4. The method of claim 1, wherein
the aqueous precursor solution including the metal salt, glycerol, and oxalic acid further includes formic acid.

5. The method of claim 4, wherein
the formic acid is converted from a part of the oxalic acid.

6. The method of claim 1, wherein
a viscosity of the aqueous precursor solution including the metal salt, glycerol, and oxalic acid is 10 cP or more to 1000 cP or less.

7. The method of claim 1, wherein
a content of water is 50 wt % or more to 99 wt % or less based on 100 wt % of the aqueous precursor solution including the metal salt, glycerol, and oxalic acid.

8. The method of claim 1, wherein
the reacting of the aqueous precursor solution including the metal salt, glycerol, and oxalic acid in the presence of the carbon-based carrier is performed in a temperature range of 60° C. or higher to 110° C. or lower.

9. The method of claim 1, wherein
the reacting of the aqueous precursor solution including the metal salt, glycerol, and oxalic acid in the presence of the carbon-based carrier includes:
a first step of preparing a slurry by dispersing a carbon-based carrier in an aqueous glycerol solution;
a second step of reacting the slurry prepared in the first step with an aqueous metal salt solution; and
a third step of reacting a reaction product of the second step with an aqueous oxalic acid solution.

10. The method of claim 9, wherein
in the first step, the aqueous glycerol solution includes glycerol and water in a weight ratio of 10:90 to 50:50.

11. The method of claim 9, further comprising wet-grinding or nano-milling the slurry prepared in the first step before adding the slurry to the second step.

12. The method of claim 9, wherein
in the second step, the aqueous metal salt solution includes a metal salt and water in a weight ratio of 30:70 to 70:30.

13. The method of claim 9, wherein
the reaction between the slurry prepared in the first step and the aqueous metal salt solution is performed in a temperature range of 60 to 110° C. for 0.1 to 24 hours.

14. The method of claim 9, wherein
in the third step, the aqueous oxalic acid solution includes oxalic acid and water in a weight ratio of 1:1 to 1:10.

15. The method of claim 9, wherein
in the third step,
the aqueous oxalic acid solution is added in a state where a temperature of the aqueous oxalic acid solution is controlled to a range of 50 to 90° C., and the reaction product of the second step and the aqueous oxalic acid solution are mixed for 5 to 10 hours while maintaining a temperature of a mixture of the reaction product of the second step and the aqueous oxalic acid solution in a range of 90 to 120° C.

16. The method of claim 1, further comprising,
after the third step, a fourth step of sequentially performing aging, filtration, washing, and drying.

17. A catalyst comprising:
a carbon-based carrier; and
a metal nanostructure supported on the carbon-based carrier,
wherein the catalyst inevitably further includes more than 0 ppm to less than 50 ppm of glycerol.

18. The catalyst of claim 17, wherein
the catalyst inevitably further includes 0 ppb or more to less than 20 ppb of oxalic acid.

19. The catalyst of claim 17, wherein
the catalyst inevitably further includes 0 wt % or more to less than 5 wt % of formic acid.

20. The catalyst of claim 17, wherein
a crystallite diameter of a (111) plane of the catalyst is 0.1 nm or more to 20 nm or less when measured by XRD analysis.

21. The catalyst of claim 17, wherein
a particle size of the catalyst is 0.1 nm or more to 20 nm or less when measured by TEM analysis.

22. The catalyst of claim 17, wherein
the catalyst has a weight retention of 97 wt % to 100 wt % when subjected to a heat treatment at 250° C., the weight retention being measured according to Equation 1:
Weight retention of catalyst=100*(A−B)/A [Equation 1]
wherein, in Equation 1,
A is a weight of the catalyst before the heat treatment, and
B is a weight of the catalyst after the heat treatment.

23. The catalyst of claim 17, wherein the catalyst is a catalyst for a fuel cell or a catalyst for water electrolysis.
